(19) United States
(12) Patent Application Publication
(10) Pub. No.: US 2023/0131179 A1
(43) Pub. Date: Apr. 27, 2023

(54) Offshore Wind Turbine Foundation

(71) Applicant: Mark Erik Riemers, Woerden (NL)

(72) Inventor: Mark Erik Riemers, Woerden (NL)

(21) Appl. No.: 17/997,442

(22) PCT Filed: Apr. 29, 2021
(86) PCT No.: PCT/NL2021/050282

§ 371 Date: Oct. 28, 2022

(30) Foreign Application Priority Data
Apr. 29, 2020 (NL) 2025456
Apr. 28, 2021 (NL) 2028088

(51) Int. Cl. E02D 27/42; E02D 27/52

(52) U.S. Cl. CPC E02D 27/425; E02D 27/525

(57) ABSTRACT

Offshore structure that is provided with a supporting system with one, two, three or more suction buckets (1) to be installed in the seabed, which buckets are fastened to the rest of the foundation system and with a star-shaped, seen in top view, connector body (6) of reinforced mineral cement concrete with the same number of external corners as there are suction buckets, which external corners are formed by the radial outwardly extending arms which provide the star shape and with a single vertical central column (5) placed centrally between the suction buckets, seen in top view, formed by a single tube and made of e.g. thin-walled steel, which carries the gondola of the windmill at its top, the gondola with the rotor blades at least 20 meters above the local water level.

The invention relates to a system to support an offshore payload, preferably an offshore wind energy installation, however also applicable to oil or gas applications. The supporting system is provided with one, two, three or more suction buckets (hereafter also called “bucket”). The supporting system is in particular designed for the next generation offshore wind energy installations of 9 or 11 MW and higher. Particularly the supporting system is designed for supporting a single upright mast (synonyms are central column, pole, post or supporting pole) which supports the payload, preferably at its top end. In case of a wind energy installation the mast preferably is provided by an upright monopole and on top of it an upright tower, wherein the tower supports the nacelle, carrying the blades, at its top. Instead of a nacelle the payload could comprise e.g. a platform, e.g. for oil or gas application or a transformer platform for an offshore substation. The mast (and thus the monopole and tower in case these provide the mast) is preferably a single tube and/or made of steel however reinforced mineral cement concrete is also feasible. The payload preferably will be located high above the sea, e.g. at least 10 or 20 metre above the water line. Sea depth typically will be at least 10 or 20 or 50 or 60 metres.

Suction buckets and how to install them are a.o. known from GB-B-2300661 and EP-B-0011894, which are enclosed in here by reference. Briefly, a suction bucket is a thin walled steel or reinforced mineral cement concrete sleeve or pipe or cylinder, which cylinder is closed at its longitudinal top end by a bulkhead (also called top plate) or different sealing means of steel or reinforced mineral cement concrete and which cylinder is sealingly located on the subsea bottom with the open end opposite the bulkhead since this open end penetrates the subsea bottom due to the weight of the suction bucket. Thus the cavity, also called suction space, delimited by the cylinder and the bulkhead is sealed by the subsea floor such that vacuum or suction can be generated by removing water from within the suction space such that a resulting force tends to force the suction bucket deeper into the subsea floor. The creation of the suction can be with the aid of a suction source, such as a pump, being on, or close to or at a distance from the suction bucket and connected to the suction space.

Suction buckets are more and more applied as (part of) a supporting system of an offshore wind energy turbine. For such application, typically three or more mutually spaced suction buckets are applied, providing a static balanced (in case of three suction buckets) or overbalanced (in case of more than three suction buckets) support. In operation, one or more of the following applies: the suction buckets have at least almost completely penetrated the sea bed; are at equal or substantially equal level; are adjacent each other or have a mutual horizontal spacing providing a clearance of at least 5 metre, typically in the order of 10 or 15 or 20 metre or more and/or less than 30 or 40 or 50 metre, e.g. between 15 and 30 or 35 metres, or a clearance of at least 0.5 or 1.0 or 1.5 times and/or less than 2.5 or 3 or 3.5 or 5 times the diameter of the suction bucket (clearance means the shortest distance between the facing side walls). This assembly of suction buckets carries a single central column supporting at its upper end the nacelle of the wind energy turbine provided with rotor blades, typically rotating around a horizontal axis and driven by the wind. The wind energy turbine converts wind energy into electrical energy. The wind turbine is typically part of a wind farm of identical wind turbines each provided with its own supporting system of three or more suction buckets. A cable brings the electricity from the wind turbine generator to an electricity consumer onshore, e.g. a household.

The structure is typically at least substantially, or completely, made from metal, typically steel and/or mineral cement concrete.

Preferably each suction bucket has one or more of: a diameter of at least 5 metres and/or less than 25 metres, typically between 7 or 10 and 15 or 20 metre or even more; a height of at least 5 or 10 metres and/or less than 20 or 30 metre; a wall thickness of at least 1 centimetre, typically at least 2, 3 or 5 and/or less than 4 or 5 or 7 centimetre; the longitudinal axis of the suction bucket and the central column are parallel and eccentric.

### OBJECT OF THE INVENTION

Particularly for wind energy turbines there are stringent requirements on many topics. Examples of these topics are: verticality of the tower for the complete service life (typically 20-25 years) of the structure; vibration frequency; low production costs; fast and efficient installation in a matter of 1-8 hours; environmental friendly; efficient recovery of verticality to repair a failure; tolerant for constructive fatigue damage.

For verticality, typically, a deviation of more than 1 degree from the vertical puts the wind turbine out of operation, which could lead to penalty claims. Such deviation can occur at any time during the lifetime of the structure, e.g. caused by settlement of the soil underneath or near the suction buckets, excessive forces from sea waves or the wind.

As an example for the vibration frequency topic, the design must be such that vibrations generated during operation may not lead to structural damage to the offshore structure. Natural frequencies play an important role. Resonance, e.g. of the type close to the natural eigen frequency of the entire structure and 1-p and 3-p (typically for 3 bladed wind turbine generators) wind turbine frequencies is preferably avoided.

The object of the invention is versatile and can be learned from the information disclosed in the application documents.

The present inventor has developed, preferably, a solution to this object embodied by a supporting system for an offshore wind energy installation, having one or more of the following: N, being exactly or at least one or two or three, suction buckets, e.g. at the corners of an imaginary, preferably regular, polygon, seen in top view; a, preferably box shaped or round or polygonal or star shaped, connector body, seen in top view, which preferably has exactly or at least N radially external corners or arms and supports the payload, e.g. the mast of the wind energy installation, preferably at its centre, and which is, at each of N mutually spaced locations, e.g. corners or distal arm ends, connected to, e.g. the top end of, a relevant suction bucket by, e.g. rigid, connection means, such that all N suction buckets are, possibly rigidly, connected to the connector body; the connector body is provided completely below sea level and/or has a hollow, e.g. box shaped, monocoque structure or load bearing skin, possibly providing radial stays and/or being non tube like; the connector body being of open or closed profile for its complete extension or part of it, if closed preferably without any slits and/or having an impermeable skin; the cross section of the connector body radially towards the outside narrows in height (i.e. axial direction of suction bucket) and/or width (i.e. tangential direction); the vertical distance between a suction bucket or its top plate and the connector body is less than 5 or 2 or 1 metre, more preferably less than 25 centimetre; vertical distance between the seabottom and the connection, e.g. weld seam or joint or coupling, of the mast to the connector body is less than 10 or 15 metre; the distance between the under side and the cover plate at the top side of, or the height of, the connector body and/or the level of the top of the connector body above the sea bottom is at least 2 or 5 and/or less than 10 or 15 metre. The invention is also defined in the claims.

Thus, the upper structure comprising the mast is supported by the connector body and the connector body is supported by the suction buckets. In different words, the upper structure rests upon the connector body and the connector body rests upon the suction buckets or the connector body rests upon the seafloor and is fixed to the seafloor by the suction buckets.

Preferably one or more of the following applies to the connector body: comprises a centrally located mast (e.g. the bottom part of it) receiving element; is made of reinforced mineral cement concrete; is thin walled; transfers all the loads (including vertical and horizontal loads, bending moments and torsion) from the mast to the suction buckets; is compact in height, e.g. to allow fabrication in a shop, which preferably does not exceed 1.5 times the outer diameter of the root of the mast; a width such that, seen in top view, the supporting system provides an envelope having a maximum span measuring at least 3 times the outer diameter of a suction bucket; overlaps, seen in top view, with the suction buckets and preferably does not radially extend beyond the suction buckets; extends substantially horizontal or at an angle of less than 10 or 20 degrees with the horizontal; substantially box shaped; made from flat sheets; one or more of side face, upper face and lower face are substantially flat and/or make corners, preferably right angled, where they mutually join and/or are locally provided with stiffeners, preferably inside; has an angular cross section, at least for its arms; is present vertically above the top plate of the suction buckets; is indeed or not free from the sea bed; keeps no gap or keeps a gap with the sea bed of at least 25 or 50 centimetre; its arms have a height, preferably measured at their location of maximum height, at least 5 and/or less than 10 or 15 metre and/or at least 0.5 or 0.6 or 0.75 and/or less than 1.5 or 2 or 2.5 times the diameter of the root of the mast (=at the level of the connector body; its arms have a width, preferably measured at their location of maximum width, at least 5 and/or less than 10 metre and/or at least 0.25 or 0.5 and/or less than 1.0 or 1.5 or 2 times the height, preferably measured at their location of maximum height, of the arms; is substantially star or triangular or square shaped as seen in top view; has a wall thickness at least 100 or 200 or 400 and/or less than 800 or 1000 or 1500 millimetre; has a substantially flat lower side; the attachment of the mast to the connector body and/or of the connector body to the suction buckets is arranged as a beam of which a single longitudinal end is fixedly wedged so that the mast extends vertically upwards from the connector body, or each suction bucket extends vertically downwards from the connector body, as a cantilever beam, in other words the mast is above the connector body, or each suction bucket is below the connector body, free from structures that transfer mechanical loads from the mast onto the seabed; the attachment of the mast to the connector body and/or of the connector body to the suction buckets is arranged such that the clearance between the mast and each suction bucket, seen in top view, is at least 2 or 3 and/or less than 7 or 10 or 15 metre. The arm (“leg” is a synonym) is the member extending from the central part towards a bucket.

If star shaped, the connector body preferably has exactly or at least three arms, each extending radially outward from the central part of the connector body, preferably of equal length and/or having identical angular spacing mutually.

The invention is based on the discovery, made by the inventor, that one or more or all the stringent requirements can be fully met by keeping the supporting system as deep as possible below the water level, preferably below 10 or 15 meters above the seabed. Thus the mast must be as long as possible.

The invention is also based on the teaching, obtained by the inventor, that one or more of the following is possible: tilting correction; ease of transport over water to the final offshore destination; deeper penetration of the suction buckets into the sea bottom; locating ballast on top of the suction buckets; minimizing pumping effect caused by cyclic loading of bucket top plate by the payload.

Ease of transport over water to the final offshore destination is preferably by designing the structure such that it has sufficient buoyancy of its own to independently float in the body of water like a vessel, preferably in the upright orientation which is the orientation of the structure when the installation is completed and the wind turbine is in full operation. The connector body and/or the suction buckets are preferably used to provide at least 50% or 75% or 90% or 95% or 99% or all of the required buoyancy of the structure, e.g. by designing them hollow, sufficiently seal the hollow spaces such that they are leak free for sea water while floating and fill the hollow spaces with a floating material, e.g. a gas or air or keep them empty. By designing the connector body and suction buckets as hollow bodies and keeping the hollow spaces empty or filled with floating material while the structure is located in the body of water, these elements can provide a water displacement such that they act like a barge or vessel to make the whole structure floating. The connector body and/or suction buckets provide stability to the whole structure that is independently floating in the body of water, also during lowering the structure onto the sea bottom. The independently floating capacity also allows limited crane support while the structure sinks to the sea bottom.

Preferably the design of the structure is such that if the connector body and/or suction buckets are completely flooded, the structure has insufficient buoyancy to independently float in the body of water, and that due to keeping hollow spaces of the connector body and/or suction buckets free from water or ballasting material the structure obtains the required buoyancy to be able to independently float in the body of water.

During tow to the final offshore destination and/or during the complete installation procedure at the final offshore destination, the structure preferably is vertically oriented (i.e. has the orientation equal to the orientation when the installation at the final offshore destination is completed) and/or comprises one or more of the connector body, the suction buckets, the coupling tube, the mast, the nacelle, the turbine blades, the upright structure extending between the connector body and the wind turbine and carrying the wind turbine, the complete wind turbine.

For one or more of the mast/monopole/tower one or more of the following applies: the lower part, i.e. root, connecting to the connector body has a diameter at least 5 metre; wall thickness at least 20 or 35 millimetre and/or less than 200 or 300 millimetre, e.g about 100 millimetre; hollow; thin walled; cylindrical for substantially its complete height; above the level of the upper face of the suction bucket top plate or the under side or top side of the connector body.

The prior art shows many proposals for a supporting system for a central column. Examples are: WO2012103867A1 (Weserwind); EP2558648B1 (Siemens); EP1805414B1 (Bard Engineering); U.S. Pat. No. 5,567,086A; EP1074663A1.

The in this application cited documents are inserted in here by reference and each provide technical background for a better understanding of this invention.

After installation into the sea bed is completed, a gap (also called “void”) can remain between the top of a soil plug inside the suction space and the closed suction bucket top. For wind turbine applications, such gap needs be filled with filler material or a filler body to prevent settlement of the suction bucket and to transfer the loads, e.g. downward or shear, from the wind turbine and structure into the seabed. This filler material provides a body (hereafter also called “slab”) inside the suction space. This slab typically has a height of at least 10 or 20 or 30 centimetres and/or less than 50 or 100 or 150 centimetres.

It is noted that the invention is preferably directed to suction buckets for supporting systems, in other words designed to carry the weight of an upper structure, e.g. wind turbine or platform, placed on top, to avoid that such upper structure sinks into the subsea bottom. Thus a supporting system suction bucket bears loads from the associated upper structure which tend to force the suction bucket further into the ground. The slab below the top bulkhead is designed to prevent that the suction bucket moves deeper into the subsea bottom due to the pushing loads generated by the weight and/or overturning moment of the upper structure. A supporting system suction bucket is by the nature of its loading different from a suction bucket for anchoring, which anchoring suction bucket must withstand pulling forces from the anchored object which tries to leave its desires location by trying to pull the anchoring suction bucket out of the subsea bottom.

Preferably one or more of the following applies: the diameter of the suction bucket is constant over its height (the height is the direction from the top bulkhead towards the opposite open end); from the top bulkhead the cylinder walls of the suction bucket extend parallel; the open end of the suction bucket, designed to be located on the sea floor first is completely open, in other words, its aperture is merely bordered by the cylinder walls; the water depth is such that the suction bucket is completely below the water surface when its lower end contacts the sea floor, in other words when its lower end has not penetrated the sea floor yet; the supporting system comprises exactly one, two, three, four or more mutually spaced suction buckets; the slab completely fills the gap; with the penetration of the suction bucket into the sea floor completed, the top bulkhead is spaced above the sea floor and/or the lower side of the slab bears onto the sea floor which is possibly at elevated level within the suction bucket, compared to the seafloor level external from the suction bucket, due to raising of the seabed plug within the suction space caused by penetration of the suction bucket into the seabed; the by releasable sealing means, e.g. a valve, selectively closable port in the top bulkhead to allow water entering and/or exiting the suction bucket is provided with a coupling means designed for temporary engagement of a suction and/or pressure pump at the time of installing, settlement correction and removing, respectively, of the suction bucket into and from, respectively, the seafloor soil, which port is associated with the fluid flow channel.

Preferably, the design of the suction bucket is such that fluid from a source, e.g. pressure pump, flows from the source through a sealed channel, terminating below the bulkhead and within the suction space. During sucking in the pressure is typically at least 0.1 or 0.25 or 0.5 or 1 bars below the local water pressure external from the suction bucket. During pressing out (correction operation or decommissioning) the pressure is typically at least 0.25 or 0.5 or 1 or 2 bars above the local water pressure external from the suction bucket.

The suction bucket is also preferably provided with known as such valves and/or hatches adjacent or at its top bulkhead for selectively allowing water and air to enter or exit the suction space through the top plate of the suction bucket.

Preferably the invention is directed to an offshore supporting system or a suction bucket of said system, the suction bucket preferably provided by an open bottom and closed top, advantageously cylindrical, elongate shell providing a suction compartment or suction space, said closed top having an externally facing upper face and an opposite, toward the suction space facing lower face and preferably provided with one or more valves selectively allowing fluid communication between the suction space and the environment. Preferably, the suction space being provided with a fixedly located slab and wherein, in use, the slab bottom bears onto a top of a soil plug inside the suction space, the top bulkhead of the suction bucket bears onto the slab.

A possible procedure is as follows: the supporting system is installed and when the buckets have arrived at their final penetration depth into the sea bed, e.g. of sand or clay, the slab, if applied, is provided by introducing the flowable filler material such that the gap is completely or substantially filled. Subsequently the upper structure to be supported by the supporting system is installed.

The connection between connector body and mast can be provided by grouting or welding or mechanical fastening means, e.g. riveting or bolting. Use of a quick coupling is preferred, e.g. of so called slip joint type, such as disclosed in EP 2 910 686 (KCI the engineers).

A quick coupling of slip joint type is preferably provided (see also the drawing) by wedging walls inclined at a sharp angle relative to the axial direction of the mast and located at the mast and/or connector body at locations where the mast penetrates into the connector body, or vice versa, and oriented such that said wedging walls extend outward from the tower, as viewed in upward direction of the mast in its final vertical attitude as installed, such that the wedging walls provide a conical shaped circumferential or peripheral, e.g. ring like, means, a first one at the mast, a second one at the connector body and configured such that if the mast and connector body are mutually penetrated or inserted, the wedging walls of the first and second one mutually engage and contact, retaining the mast against further lowering by gravity action and also generating radially inward directed clamping forces between these wedging walls, keeping the tower clamped to the connector body. The first one and the second one make a pair and preferably there are two pairs, mutually spaced axially of the mast, at least 0.5 meter.

The invention is e.g. applicable to an offshore structure wherein the suction buckets are rigidly connected to the supporting system and/or have a fixed position relative to the supporting system.

Preferably, the connector body is provided with at least two or three separate, preferably mutually spaced, ballast spaces, e.g. tanks, preferably each located at a corner of an imaginary, triangle or rectangle or polygon, preferably with all sides of equal length, seen in top view or along the tower longitudinal axis, preferably outside the radial extend of the tower or part of it, e.g. foot or root. These are preferably connected to fill means for ballast material, e.g. liquid, preferably designed to control the fill level of each ballast space individually, e.g. by way of individual fill valves and/or supply means, e.g. pumps. In this manner, in particular with at least three ballast spaces, the vertical attitude of the offshore structure during floating in the body of water can be levelled or adjusted, e.g. by providing mutually differing fill levels of these ballast spaces. Preferably, the walls of the ballast spaces are provided by cement concrete and/or the ballast spaces contain a dividing wall, dividing the ballast space in two, radially.

The connector body preferably comprises (viz. e.g. FIG. 12-13), seen in top view or along the tower longitudinal axis, a central core member and exactly or at least three from the central core member radially and/or horizontally outward extending, preferably equally long and/or hollow, arms, preferably of rectangular cross section and mutually keeping an equal angular spacing. The core member is designed for fastening of, or is fastened to, the mast root (synonym=foot). The radial outer ends of the arms connect each to a relevant suction bucket, e.g. directly or through an intermediate member. The suction buckets are e.g. located at the corners of a triangle, rectangle or polygon, with straight sides of equal length, and preferably these sides are provided by flat sheets that are oriented vertically or parallel to the tower longitudinal axis. Each arm preferably contains a ballast space. Going along an arm towards the relevant suction bucket, the distance between this arm and associated flat sheet (providing the side of the polygon) decreases continuously. Preferably, from each flat sheet, approximately midway its length from the one to the other associated suction bucket, a flat cross sheet extends and connects to the central core member, providing a dividing wall of the space at the inward facing face of the associated flat sheet. A cover plate at top and bottom are sealed to all the flat sheets (providing the side of the polygon), wherein these cover plates and flat sheets provide the external boundary of the connector body, such that the inner space delimited by these cover plates and flat sheets is sealed from the environment and could be used as a buoyancy body.

Preferably, one or more of the walls and dividing walls of the ballast spaces, the flat sheets, the arms and the cover plates are provided by reinforced mineral cement concrete.

Preferably, the applied mineral cement concrete is at least C30/37 or C35/45 or C40/50 (according to NEN-EN206-1:2014) and/or at least 2400 kg/m3 specific weight. Everywhere in this disclosure, “concrete”, “cement concrete” and “mineral cement concrete” mean “reinforced mineral concrete” (“prestressed reinforced mineral concrete” is a synonym).

The words “central column”, “mast”, “monopole” and “tower” have individual meaning, however also identical meaning, e.g. more general, such as: each being an elongated tube or pole like object. Thus, if any of these four words is used in this disclosure, it can also have a meaning identical to any of the three other of these four words and/or the more general meaning. In here, the word “mast” could also mean a length part of it, e.g. the lower length part of it, typically the monopole.

The invention is further illustrated by way of non-limiting, presently preferred embodiments providing the best way of carrying out the invention and shown in the drawings, showing:

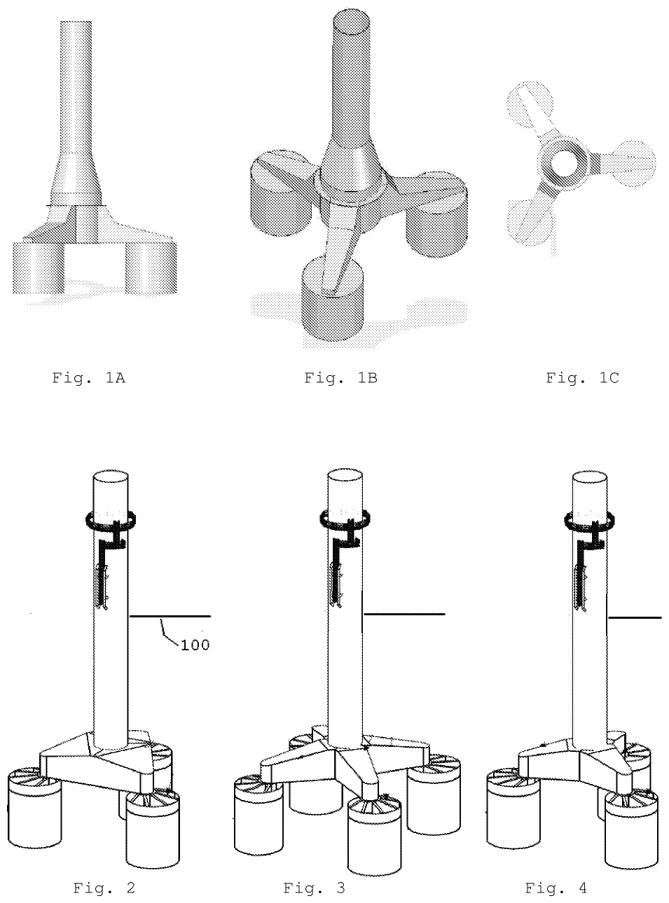

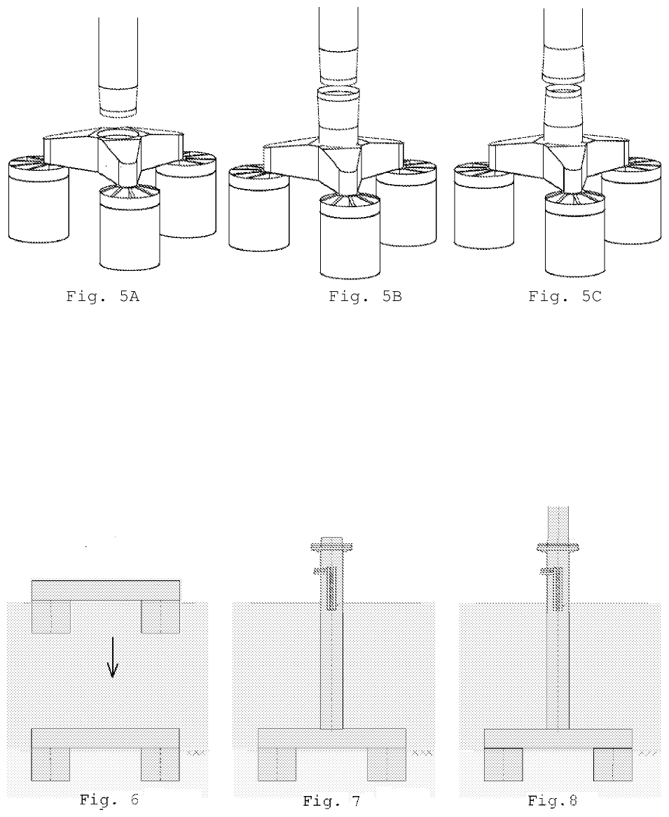

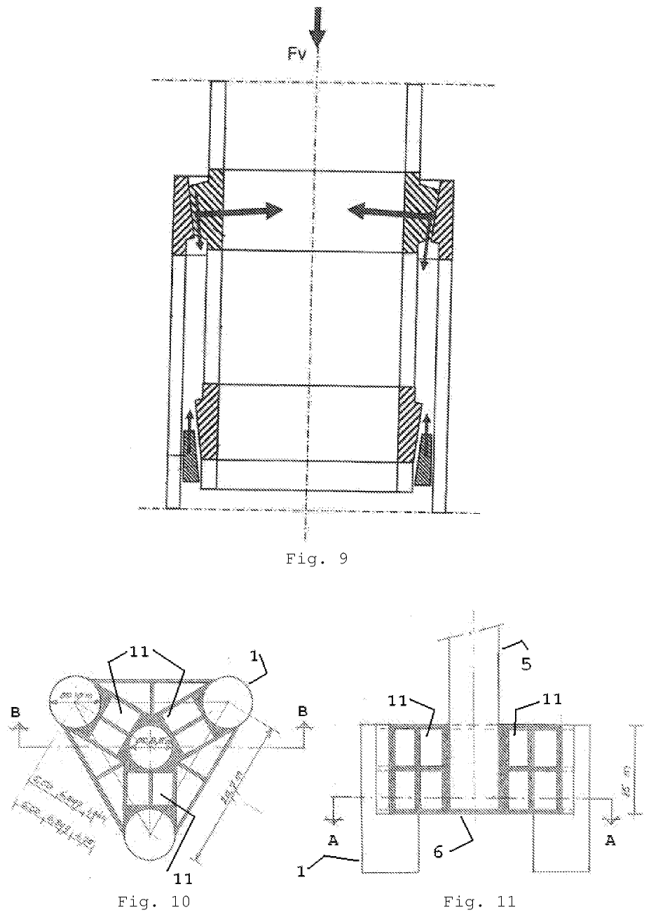

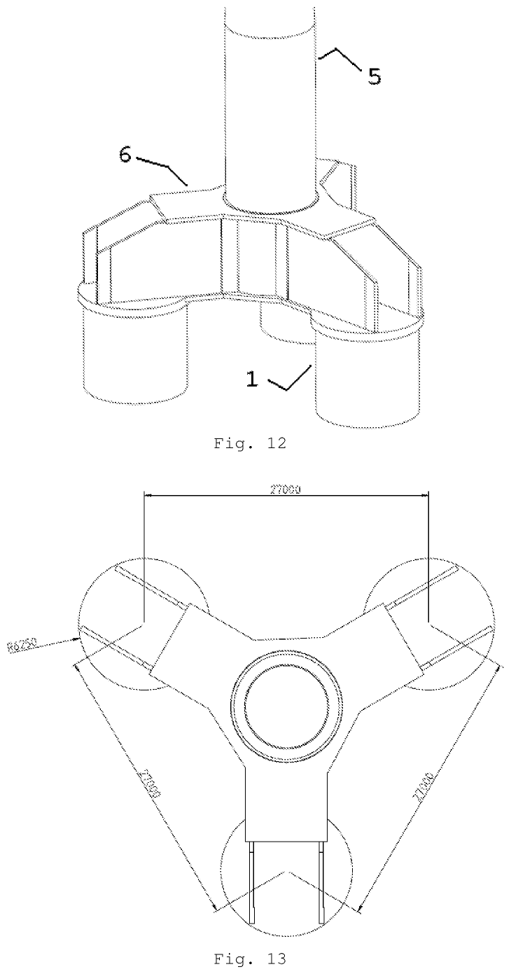

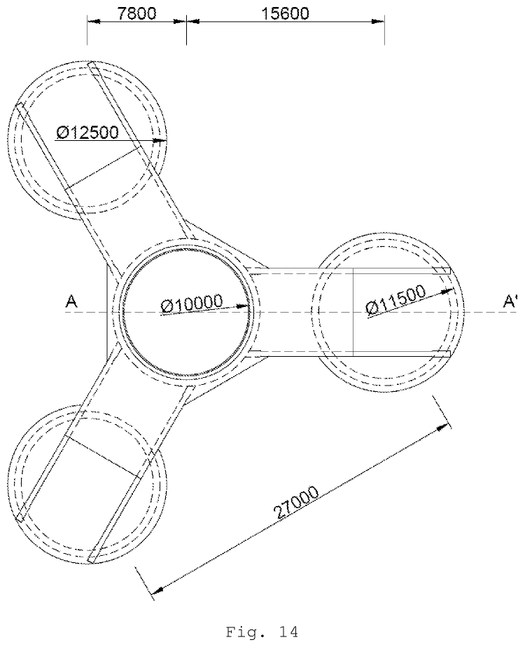

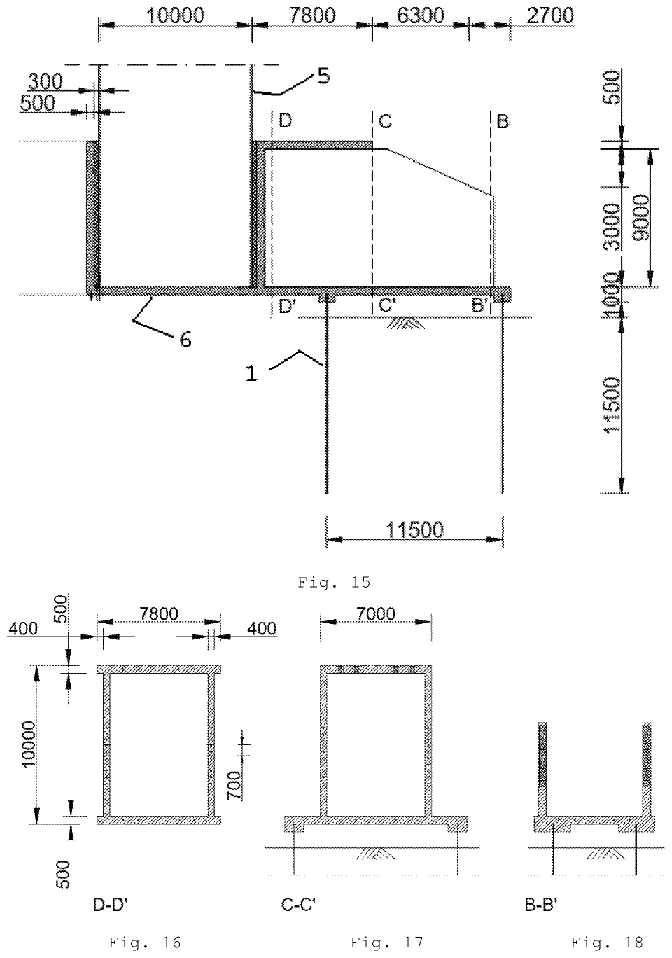

FIG. 1A-C a first example of a connector body from three different angles; FIG. 2-4 a perspective view of a second, third and fourth example of a connector body, respectively; FIG. 5A-C a perspective view, of exploded type, of three alternative ways of mounting the monopole to the supporting system; FIG. 6-8 in side view the three main phases during a possible manner of installing the offshore wind energy installation; FIG. 9 a double slip joint in section from the side; FIG. 10-11 the cross section A-A and B-B of a modification of the FIG. 2 connector body, fabricated from reinforced mineral cement concrete; FIG. 12-23 a further embodiment in different views, wherein the connector body is fabricated from reinforced mineral cement concrete.

FIG. 1 shows three suction buckets, on top of it a star shaped connector body having three arms, each radially outward converging, and there above a single upright tube providing a mast. The lower part of the mast has a conical shape.

FIG. 2 shows three suction buckets, there above a triangular shaped connector body and there above a prismatic mast. The water level 100 is also illustrated. FIG. 3 shows four suction buckets, a star shaped connector body having four arms and above it a prismatic mast. FIG. 4 shows a star shaped connector body having three arms and a prismatic mast. At the radially outer end of each of its three (FIG. 4) or four (FIG. 3) arms, or at each of its three corners (FIG. 2), the connector body is mounted to a suction bucket 1.

In FIG. 5A the lower end of the mast penetrates the connector body. In FIG. 5B the lower end of the mast penetrates a from the connector body upwards projecting coupling tube. In FIG. 5C the coupling tube penetrates the lower end of the mast. In all three cases the slip joint can be applied.

According to FIG. 6, the suction buckets and connector body provide a sub assembly separate from the mast. This subassembly was sailed to its final offshore location and there the suction buckets were penetrated into the sea bed. After that part of the lower part of the mast (e.g. the monopole) was added (FIG. 7) and after that the upper part of the mast (e.g. tower) was added (FIG. 8). The relative location of the water line during tow (WLtow) and if the installation of the structure at the final offshore destination is completed (WLfinal) and of the sea bottom (ML) are indicated.

Different from FIG. 6-8, an alternative manner of installation is to sail the subassembly shown in FIG. 7 (buckets, connector body 6 and monopole 5 mutually assembled at a remote location) to the final offshore location and install it there, after which the payload (e.g. tower+wind turbine) is added.

FIG. 9 shows an inner tube, e.g. the monopole, and an outer tube, e.g. the wall of the central hole of the connector body to receive the monopole. Each tube is provided with two axially spaced conical rings, providing two pairs of each an inner ring of the inner tube and an outer ring of the outer tube. Due to the downward directed force Fv, oriented according to the gravity force, the radially inward directed clamping forces are generated (only shown for the upper pair).

The connector 6 body typically comprises a floor plate and a roof plate, mutually opposite and spaced, and two web plates, mutually opposite and spaced and bridging the floor and roof plate, such that these four plates provide a box shaped structure, extending horizontally. The monopole 5 e.g. passes through the roof plate (viz. FIG. 5A) or ends above the roof plate (viz. FIG. 5B or 5C). The floor plate and/or the roof plate preferably comprise a central section and at least three arm sections extending radially outward from the central section, to provide a star shaped plate.

Preferably, the thickness of at least one of the floor plate, roof plate and web plate, is at least 5 or 10 and/or less then 20 or 30 times the thickness of the axial wall of the suction bucket.

FIG. 10-11 show ballast tanks 11 integrated within the connector body 6. Different from the FIG. 2 embodiment, the roof of the connector body 6 is level with the top of the suction buckets 1.

FIG. 12-21 show a further embodiment of the connector body. The floor of the connector body is level with the top of the suction bucket. Importantly, the top bulkhead of the suction bucket is provided by reinforced mineral cement concrete and simultaneously provides the floor of the connector body, thus the top bulkhead and the floor are integrated parts. As an alternative, e.g. based on the FIG. 10-12 embodiment, the top bulkhead of the suction bucket and the roof of the connector body could be integrated parts.

The floor (and thus the top bulkhead) completely covers the space enclosed by the outer circumference of the axial wall of the suction bucket and also extends outside said outer circumference at all radial locations. Thus, the floor (or the roof in case of the alternative embodiment) provides an gas tight oversized uninterrupted cover of the axial wall of the suction bucket.

As FIGS. 15, 17, 18 and 20 show, the top bulkhead is provided with a downward directed flange 2 (length e.g. at least 10 centimetre) overlapping with and fastened to the top part of the axial wall 1 (i.e. the cylindrical wall) of the suction bucket, for load transfer between the connector body and the suction bucket and/or for a gas tight connection of the top bulkhead to the axial wall of the suction bucket, required to be able to generate a vacuum within the suction bucket to suck the bucket into the sea bottom. Preferably, this flange 2, extending completely around the axial wall of the suction bucket, is one or more of: made of concrete; cast against the axial wall of the suction bucket; integral part of the top bulkhead; encloses the axial wall of the suction bucket internally and externally (e.g. the axial wall of the suction bucket is embedded in the flange (viz. FIG. 15), or is sandwiched between a flange pair (viz. FIG. 20). Preferably, anchor elements 3 penetrate the axial wall of the suction bucket and the flange, to increase the loading capacity.

Preferably, a sealing element 4, e.g. of neoprene or other elastomeric material, is applied in the joint between the axial wall of the suction bucket and the top bulkhead, to improve the gas tight connection.

FIG. 16-18 show the cross sections indicated in FIG. 15. Prestressing tendons, preferably of steel, are embedded internally of each of the roof plate, floor plate and web plates. Preferred tendon cross section diameter: at least 25 or 30 and/or less than 50 or 60 millimetre. Preferably, a tendon is build up of multiple strands, e.g. et least four and/or less than fourty, each with a cross section of at least 100 or 140 and/or less than 200 or 150 square millimetre.

FIG. 19-20 show design details of the connection between the mast and the connector body, and of the connection between the connector body 6 and the suction bucket 1, respectively. The connector body has, preferably arranged in the central area, a first connection area that is prepared and arranged to connect a wind turbine mast 5 to the connector body. The connector body has, preferably at the distal end of each arm, a second connection area that is prepared and arranged to connect a suction bucket to the connector body.

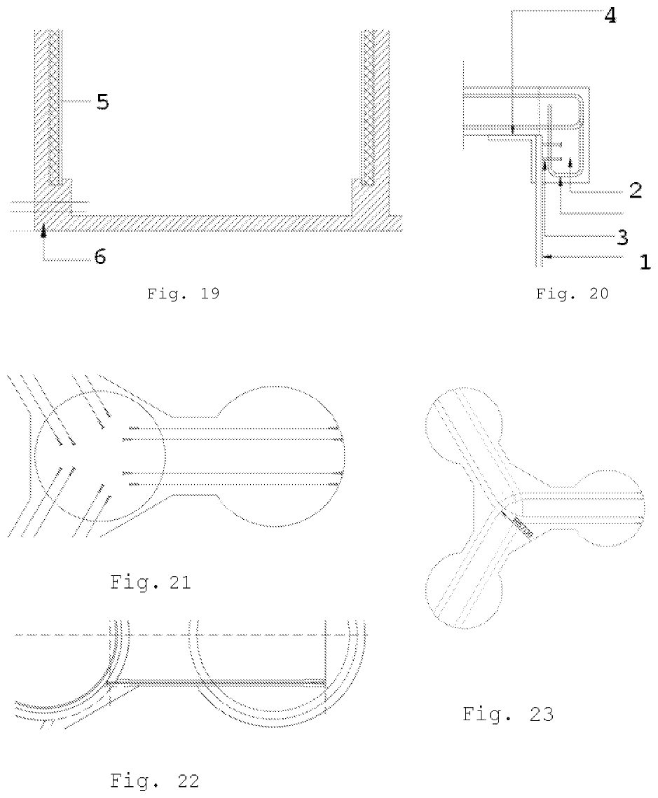

FIG. 21-23 show design alternatives for the tendons.

The invention is not limited to the above described and in the drawings illustrated embodiments. E.g. the marine structure can have a different number of suction buckets. The drawing, the specification and claims contain many features in combination. The skilled person will consider these also individually and combine them to further embodiments. Features of different in here disclosed embodiments can in different manners be combined and different aspects of some features are regarded mutually exchangeable. All described or in the drawing disclosed features provide as such or in arbitrary combination the subject matter of the invention, also independent from their arrangement in the claims or their referral.

1. (canceled)

2. (canceled)

3. (canceled)

4. (canceled)

5. (canceled)

6. (canceled)

7. (canceled)

8. (canceled)

9. (canceled)

10. (canceled)

11. An offshore structure that is provided with a supporting system with one, two, three, or more suction buckets to be installed in a seabed, wherein the suction buckets are fastened to the rest of a foundation system, wherein the offshore structure comprises a star-shaped connector body of reinforced mineral cement concrete with the same number of external corners as there are suction buckets, wherein external corners are formed by arms that extend radially outward and provide the star shape, wherein a floor or roof of the star-shaped connector body is level with a top bulkhead of a suction bucket, and wherein the top bulkhead of the suction bucket is provided by reinforced mineral cement concrete and simultaneously provides the floor or roof, respectively, of the star-shaped connector body.

12. The offshore structure according to claim 11, wherein the top bulkhead of the suction bucket and the floor or roof of the star-shaped connector body are integrated parts.

13. The offshore structure according to claim 11, wherein a single vertical central column is placed centrally between the suction buckets, seen in top view, and wherein the single vertical central column is formed by a single tube, which is configured to carry a gondola of a windmill at its top such that the gondola has rotor blades at least 20 meters above a local water level.

14. The offshore structure according to claim 13, where, if completely installed:
the single vertical central column, the star-shaped connector body, and the suction buckets are rigidly mounted so that all loads (including vertical and horizontal loads), bending moments, and torsion are transmitted from the single vertical central column to the suction buckets via the star-shaped connector body;
an attachment of the single vertical central column to the star-shaped connector body or of the star-shaped connector body to the suction buckets is arranged as a beam of which a single longitudinal end is fixedly wedged so that the single vertical central column extends vertically upwards from the star-shaped connector body;
each suction bucket extends vertically downwards from the star-shaped connector body, as a cantilever beam, in other words the single vertical central column is above the connector body; or
each suction bucket is below the star-shaped connector body, free from structures that transfer mechanical loads from the single vertical central column onto the seabed.

15. The offshore structure according to claim 13, wherein the foundation system:
extends less than 15 meters above a local seabed; and
is located completely below the highest point of the star-shaped connector body, and
wherein, only in an area downwards from the highest point of the star-shaped connector body are there any structures that: (i) extend from the star-shaped connector body; (ii) are attached to the single vertical central column; and (iii) transfer any load from the single vertical central column to the seabed.

16. The offshore structure according to claim 11, wherein the floor or roof of the star-shaped connector body completely covers a space enclosed by an outer circumference of an axial wall of the suction bucket and also extends outside the outer circumference at all radial locations.

17. The offshore structure according to claim 11, wherein the floor or the roof of the star-shaped connector body provides a gas-tight, oversized, uninterrupted cover of an axial wall of the suction bucket.

18. The offshore structure according to claim 11, wherein the star-shaped connector body comprises:
a floor plate and a roof plate, wherein the floor plate and the roof plate are mutually opposite and spaced; and
two web plates, wherein the two web plates are mutually opposite, spaced, and bridge the floor and roof plate such that these four plates provide a box shaped structure that extends horizontally.

19. The offshore structure according to claim 18, wherein the offshore structure is configured to allow a mast to pass through a roof plate or to end above the roof plate.

20. The offshore structure according to claim 11, wherein the star-shaped connector body comprises:
a floor plate and a roof plate, wherein the floor plate and the roof plate are mutually opposite and spaced; and
two web plates, wherein the two web plates are mutually opposite, spaced, and bridge the floor and roof plate, and wherein a thickness of at least one of the floor plate, the roof plate, and the web plate is between 5 times and 30 times a thickness of an axial wall of the suction bucket.

21. The offshore structure according to claim 20, wherein the top bulkhead of a suction bucket comprises a downward-directed flange, and wherein the downward-directed flange overlaps with and is fastened to a top part of an axial wall of the suction bucket to provide: (i) a load transfer between the star-shaped connector body and the suction bucket or (ii) a gas-tight connection of the top bulkhead to the axial wall of the suction bucket, which is usable to generate a vacuum within the suction bucket that sucks the suction bucket into a sea bottom.

22. The offshore structure according to claim 21, wherein the downward-directed flange is configured to extend completely around the axial wall of the suction bucket, and wherein the downward-directed flange:
is made of concrete;
is cast against the axial wall of the suction bucket;
is integrated into the top bulkhead;
encloses the axial wall of the suction bucket internally and externally; or
is sandwiched between a flange pair.

23. The offshore according to claim 21, further comprising:
anchor elements configured to penetrate the axial wall of the suction bucket and the downward-directed flange to increase a loading capacity;
a sealing element of neoprene or other elastomeric material applied in a joint between the axial wall of the suction bucket and the top bulkhead, wherein the sealing element improves the gas-tight connection;
prestressed tendons of steel embedded internally into the roof plate, the floor plate, or the web plates, wherein a cross-sectional diameter of the prestressed tendons is between 25 mm and 60 mm;
a tendon built-up of multiple strands, each with a cross-sectional area of between 100 mm² and 200 mm²;
a connector body having, arranged in a central area, a first connection area that is prepared and arranged to connect a wind turbine mast to the connector body; or
a connector body having, at a distal end of each arm, a second connection area that is prepared and arranged to connect a suction bucket to the connector body.

24. A star-shaped connector body for use in the offshore structure according to claim 11.
